(19) United States
(12) Patent Application Publication
(10) Pub. No.: US 2005/0262446 A1
(43) Pub. Date: Nov. 24, 2005

(54) Display apparatus and control method thereof

(76) Inventor: Joung-ho Roh, Suwon-si (KR)

Correspondence Address: STANZIONE & KIM, LLP, 919 18TH STREET, N.W., SUITE 440, WASHINGTON, DC, 20006, US

(21) Appl. No.: 11/118,627

(22) Filed: May 2, 2005

(30) Foreign Application Priority Data
May 1, 2004 (KR) 2004-30826

(51) Int. Cl. G06F 17/00

(52) U.S. Cl. 715/733

(57) ABSTRACT

A display apparatus displaying a picture, including an input unit having a setting key to set picture quality of the picture, and an automatic key to automatically set the picture quality of the picture; a picture analyzer to analyze characteristics of the picture; a memory to store a setting value set through the setting key and the characteristics of the picture, which are mapped each other; a controller allowing the characteristics of the picture analyzed by the picture analyzer to be mapped with the setting value set by the setting key and stored in the memory when the picture quality is set through the setting key, and reading the nearest value to the characteristics of the picture analyzed by the picture analyzer from the memory when the automatic key is selected, so as to set the picture quality on the basis of the setting value corresponding to the nearest picture analyzed value read from the memory. With this configuration, the present general inventive concept provides a display apparatus and a control method thereof, which saves a user the trouble of setting picture quality every time a picture varies in characteristics.

### CROSS-REFERENCE TO RELATED APPLICATIONS

This application claims the benefit of Korean Patent Application No. 2004-80326, filed May 1, 2004, in the Korean Intellectual Property Office, the disclosure of which is incorporated herein in its entirety.

### BACKGROUND OF THE INVENTION

1. Field of the Invention

The present general inventive concept relates to a display apparatus and a control method thereof, and more particularly, to a display apparatus and a control method thereof, which saves a user the trouble of setting picture quality every time in which a picture varies in characteristics.

2. Description of the Related Art

In a display apparatus, a user wants the display apparatus to display a picture with optimum picture quality.

As everyone has his/her own taste, he/she recognizes a picture differently in picture quality. From this point of view, there is no absolute setting value with regard to the optimum picture quality. Of course, the setting value for the picture quality can be universally optimized, but existence of a picture quality setting function for the display apparatus proves that the optimum picture quality is very subjective.

Currently, a manufacturer provides the display apparatus with a default setting value for the picture quality, and a user can change the default setting value according to characteristics of a picture through the picture quality setting function. However, in this case, the picture quality is optimized with regard to a picture having the characteristics the same as that of which the setting value is adjusted, so that a picture having different characteristics cannot be displayed with the optimum picture quality. Therefore, a user has to optimize the picture quality every time in which a picture varies in characteristics thereof.

### SUMMARY OF THE INVENTION

Accordingly, it is an aspect of the present general inventive concept to provide a display apparatus and a control method thereof, which saves a user the trouble of having to set a picture quality every time in which a picture varies in characteristics.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a display apparatus displaying a picture, the display apparatus including an input unit including a setting key to set picture quality of the picture, and an automatic key to automatically set the picture quality of the picture; a picture analyzer to analyze characteristics of the picture; a memory to store a setting value set through the setting key and the characteristics of the picture, which are mapped with each other; a controller allowing the characteristics of the picture analyzed by the picture analyzer to be mapped with the setting value set by the setting key and stored in the memory when the picture quality is set through the setting key, and reading the nearest value of the characteristics of the picture analyzed by the picture analyzer from the memory when the automatic key is selected, so as to set the picture quality on the basis of the setting value corresponding to the nearest picture analyzed value read from the memory.

According to an aspect of the present general inventive concept, the picture analyzer may include at least one of a temporary picture storage to temporarily store the picture, an image movement determiner to determine movement of an image in the picture stored in the temporary picture storage, a discrete cosine transform (DCT) operator to applying a DCT operation to the picture stored in the temporary picture storage and to analyze frequency distribution of the picture with respect to frequency bands, a histogram determiner to determine a histogram for the picture stored in the temporary picture storage, and a picture shift determiner to determine a picture shift on the basis of results from the image movement determiner, the DCT operator, and the histogram determiner.

According to an aspect of the present general inventive concept, the setting value set through the setting key may include at least one of an edge enhancement value, a brightness value, and a contrast value, and the controller allows a high frequency component and a DC component operated by the DCT operator, and a histogram distribution determined by the histogram determiner to be mapped with the edge enhancement value, the brightness value, and the contrast value, respectively, and stored in the memory.

The foregoing and/or other aspects and advantages of the present general inventive concept may also be achieved by providing, a method of controlling a display apparatus that displays a picture, the method including analyzing characteristics of the picture, mapping and storing the analyzed characteristics of the picture with a setting value when picture quality of the picture is set, and setting the picture quality of the picture on the basis of the setting value corresponding to the stored value nearest to the analyzed characteristics of the picture when automatic setting is selected.

According to an aspect of the present general inventive concept, the analyzing of the characteristics of the picture may include storing the picture temporarily, determining movement of the temporarily stored picture, applying a DCT operation to the temporarily stored picture to analyze frequency distribution of the picture with respect to frequency bands, determining a histogram for the temporarily stored picture, and determining a picture shift on the basis of the image movement, the frequency distribution, and the histogram

### BRIEF DESCRIPTION OF THE DRAWINGS

The above and/or other aspects and advantages of the present general inventive concept will become apparent and more readily appreciated from the following description of the embodiments, taken in conjunction with the accompany drawings of which:

FIG. 1 is a control block diagram of a display apparatus according to an embodiment of the present general inventive concept;

FIG. 2 is a detailed block diagram of an example of a picture analyzer of FIG. 1;

FIG. 3 is a view illustrating an example of a structure of a memory of FIG. 1;

FIG. 4 is a flowchart of a user's adjustment for picture quality in the display apparatus according to an embodiment of the present general inventive concept; and

FIG. 5 is a flowchart of automatic adjustment for picture quality in the display apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

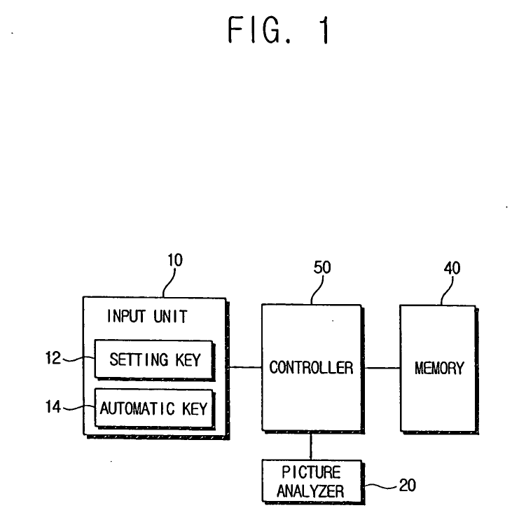

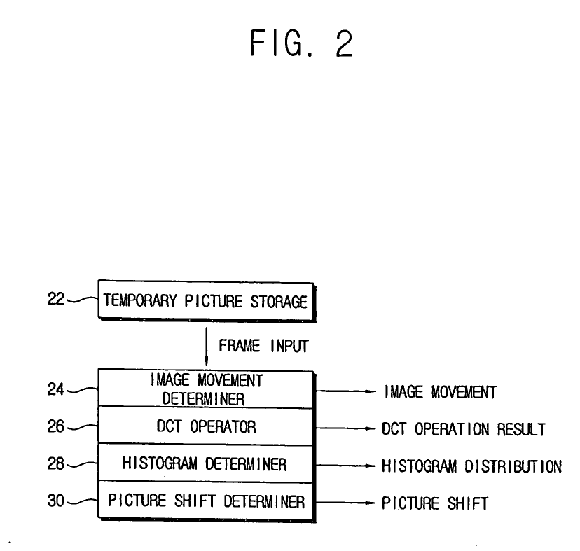

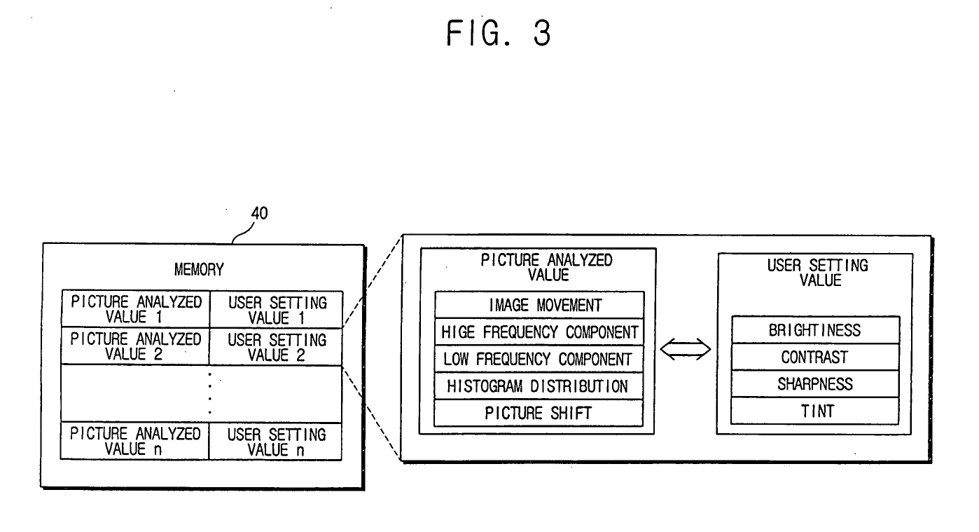

FIG. 1 is a control block diagram of a display apparatus according to an embodiment of the present general inventive concept; FIG. 2 is a detailed block diagram of an example of a picture analyzer used in the display apparatus of FIG. 1; and FIG. 3 is a view illustrating an example of a structure of a memory used in the display apparatus of FIG. 1.

As shown in FIG. 1, a display apparatus according to an embodiment of the present general inventive concept may include a user input unit 10 for a user's input, a picture analyzer 20 to analyze characteristics of a picture, a memory 40, and a controller 50 that controls the user input 10, the picture analyzer 20 and the memory 40.

The user input unit 10 may include a setting key 12 allowing a user to set picture quality, and an automatic key 14 allowing the picture quality to be automatically set. Here, when the setting key 12 is selected, the display apparatus can display a picture quality setting menu or a picture quality setting bar on its screen. Hence, a user can set the picture quality as desired through the picture quality setting menu or the picture quality setting bar. Here, the setting key 12 and the automatic key 14 can be a button provided on a casing of the display apparatus, a key of a keyboard, and a button of a remote controller.

The picture analyzer 20 may be used to analyze the picture quality. As shown in FIG. 2, the picture analyzer 20 may include a temporary picture storage 22 to temporarily store a picture, an image movement determiner 24 to determine movement of an image in the picture, a discrete cosine transform (DCT) operator 26 to implement a DCT operation, a histogram determiner 28 to determine a histogram for the picture, and a picture shift determiner 30 to determine whether a picture shifts.

The temporary picture storage 22 temporarily stores a frame of the picture when a user pushes a store button (not shown) after selecting the setting key 12 to set the picture quality, or temporarily stores several neighboring frames such as an anterior frame, a posterior frame, etc., as well as a current frame.

The image movement determiner 24 reads the frames of the picture stored in the temporary picture storage 22 and calculates a movement vector of an image, thereby estimating the movement of the image. Here, the movement vector indicates a directional moving quantity of an image of a moving object in a picture between the anterior frame and the posterior frame, and is represented as vertical and horizontal components. For example, a movement vector of (2, −3) means that an image moves by 2 pixels in a horizontal direction and −3 pixels in a vertical direction. Here, the image movement determiner 24 determines whether the image moves by a large amount or a small amount on the basis of the calculated movement vector. For example, the movement of the image may be classified into grades previously assigned in a table. The method of calculating the movement vector is well known, and therefore its detailed descriptions will be omitted. Meanwhile, to estimate the movement of an image, the image movement determiner 24 can use the current frame and the anterior frame, the current frame and the posterior frame, or the current frame and both the anterior and posterior frames according to operations of the temporary picture storage 22.

The DCT operator 26 reads the frame stored in the temporary picture storage 22 and implements the DCT operation, thereby analyzing frequency distribution of the picture with respect to frequency bands. The DCT operation transforms the image from a spatial domain to a frequency domain.

The DCT operator 26 classifies an AC component frequency band into the grades from “0” to “100” according to the domains, and determines the frequency band near “0” as a low frequency component and the frequency band near “100” as a high frequency component. Such results of the DCT operation can be mapped and stored by a one-to-one correspondence with edge enhancement values previously set by a user through the setting key 12. Further, the “0” frequency band (DC component) indicates brightness of the screen, so that it can be mapped with a brightness level previously set by a user through the setting key 12. Thus, each picture analyzed value and a user setting value may be mapped by a one-to-one correspondence, but are not limited thereto, and may be mapped by various other methods.

The histogram determiner 28 reads the frame stored in the temporary picture storage 22 and analyzes the histogram for the picture, thereby determining characteristics of the picture. The histogram represents a distribution of brightness levels for each pixel forming a picture. That is, the brightness level is classified into values from “0” to “255” according to brightness, and the brightness is statistically distributed according to the brightness levels such as “0”, “1”, . . . , “255”. On the basis of the histogram, the characteristics of the picture are determined, for example, it is determined whether the whole picture is bright or dark and how the brightness levels are distributed. Thus, the distribution of the histogram can be mapped by a one-to-one correspondence with a contrast value, but is not limited thereto, and may be mapped by various other methods.

The picture shift determiner 30 collectively considers the movement vector calculated by the image movement determiner 24, the DCT operation results of the DCT operator 26, and the distribution of the histogram determiner 28, thereby determining a picture shift region and the frame including an image moving by a large amount. That is, the picture shift determiner 30 determines a picture shift due to a zoom, panning, flash right, etc., or the frame including an image moving by a large amount, and manages them separately.

In the memory 40, as shown in FIG. 3, the picture analyzed value of when a user sets the picture quality through the setting key 12 is mapped with the user setting value. Here, the picture analyzed value includes information about the image movement characteristic analyzed by the picture analyzer 20, the high frequency component, the low frequency component, the distribution of the histogram, and the picture shift. Further, the user setting value includes information about brightness, contrast, sharpness, and tint, wherein such user setting value continuously remains as a database as long as a user does not forcibly reset it.

The controller 50 maps the user setting value adjusted by a user through the setting key 12 with regard to the picture analyzed value outputted from the picture analyzer 20 when a user sets the picture quality, and stores it in the memory 40. When the automatic key 14 is selected, the controller 50 reads the nearest value to the picture analyzed value of the current picture from the memory 40. At this time, the controller 50 sets the register value to apply the user setting value mapped with the picture analyzed value read from the memory 40 to the picture quality of the current picture.

According to an embodiment of the present general inventive concept, the user setting value optimized by a user is mapped with the characteristics of the picture and is then stored for a later setting. Further, when the automatic key 14 is selected, the user setting value is restored to the optimum user setting value set by a user according to the characteristics of the picture, thereby saving a user from the trouble of setting the picture quality every time a picture varies in characteristics.

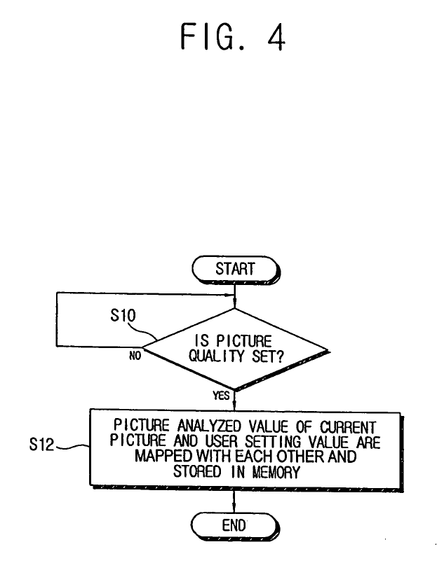

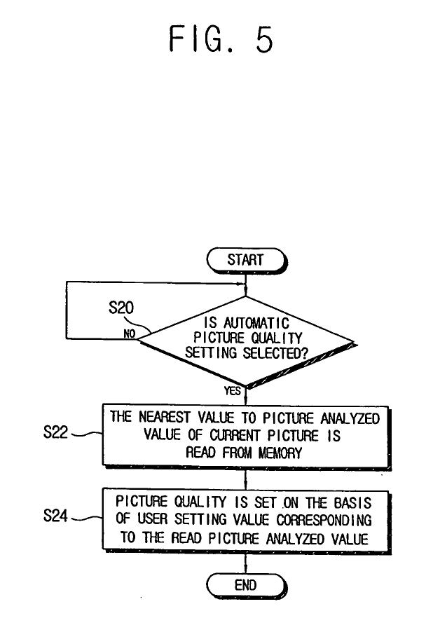

FIG. 4 is a flowchart of user's adjustment for picture quality in the display apparatus according to an embodiment of the present general inventive concept; and FIG. 5 is a flowchart of automatic adjustment for picture quality in the display apparatus according to an embodiment of the present general inventive concept.

As shown in FIG. 4, at operation S10, a user starts setting the picture quality through the setting key 12. Then, at operation S12, the controller 50 maps the picture analyzed value outputted from the picture analyzer 20 with the user setting value, thereby storing them in the memory 40. These processes are repeated every time a user sets the picture quality through the setting key 12.

As shown in FIG. 5, at operation S20, a user selects the automatic key 14. Then, at operation S22, the controller 50 reads the nearest value to the picture analyzed value of the current picture outputted by the picture analyzer 20 from the memory 40. Then, at operation S24, the controller 50 sets the picture quality on the basis of the user setting value corresponding to the nearest picture analyzed value read from the memory 40. For example, the control flows of FIGS. 4 and 5 may be as follows.

When a user increases the brightness level of a picture including a very dark picture moving by a large amount, the controller 50 maps a picture analyzed value (A) of when a user increases the brightness with a register value (A′) set by a user, and then stores it in the memory 40.

Thereafter, the display apparatus displays a picture having different characteristics, for example, a picture including a wholly bright image moving by a small amount, wherein a user feels that the picture quality is not optimized, and therefore resets the picture quality through the setting key 12. At this time, the controller 50 maps a picture analyzed value (B) of when a user sets the picture quality with a register value (B′) set by a user, and then stores it in the memory 40.

When a user selects the automatic key 14, the controller 50 reads the nearest value to, the picture analyzed value outputted by the picture analyzer 20 from the memory 40. Then, the controller 50 reads the user setting value mapped with the nearest picture analyzed value and sets the register value on the basis of the user setting value.

In the foregoing embodiment, the picture analyzed value may include information about the image movement characteristic analyzed by the picture analyzer 20, the DCT operation result, the distribution of the histogram, and the picture shift, by way of example, but is not limited to.

Thus, the setting values for the picture quality optimized by a user are systematically analyzed, managed and stored, so that the optimum picture quality set by a user is automatically stored and restored, thereby saving a user the trouble of setting a picture quality every time a picture varies in characteristics.

As described above, the present general inventive concept provides a display apparatus and a control method thereof, which can save a user the trouble of setting picture quality every time a picture varies in characteristics.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display apparatus displaying a picture, comprising:
an input unit including a setting key to set picture quality of the picture, and an automatic key to automatically set the picture quality of the picture;
a picture analyzer to analyze characteristics of the picture;
a memory to store a setting value set through the setting key and the characteristics of the picture, which are mapped with each other; and
a controller allowing the characteristics of the picture analyzed by the picture analyzer to be mapped with the setting value set by the setting key and stored in the memory when the picture quality is set through the setting key, and reading the nearest value to the characteristics of the picture analyzed by the picture analyzer from the memory when the automatic key is selected, so as to set the picture quality on the basis of the setting value corresponding to the nearest picture analyzed value read from the memory.

2. The display apparatus according to claim 1, wherein the picture analyzer comprises at least one of:
a temporary picture storage to temporarily store the picture;
an image movement determiner to determine movement of an image in the picture stored in the temporary picture storage;
a discrete transform cosine (DCT) operator to applying a DCT operation to the picture stored in the temporary picture storage and to analyze frequency distribution of the picture with respect to frequency bands;
a histogram determiner to determine a histogram for the picture stored in the temporary picture storage; and
a picture shift determiner to determine a picture shift on the basis of results from the image movement determiner, the DCT operator, and the histogram determiner.

3. The display apparatus according to claim 2, wherein the setting value set through the setting key includes at least one of an edge enhancement value, a brightness value, and a contrast value, and
the controller allows a high frequency component and a DC component operated by the DCT operator, and a histogram distribution determined by the histogram determiner to be mapped with the edge enhancement value, the brightness value, and the contrast value, respectively, and stored in the memory.

4. The display apparatus according to claim 1, wherein when the setting key is selected, the display apparatus displays either a picture quality setting menu or a picture quality setting bar such that the picture quality can be set through the picture quality setting menu or the picture quality setting bar.

5. The display apparatus according to claim 1, wherein the setting key and the automatic key are at least one of a button provided on a casing of the display apparatus, a key of a keyboard, and a button of a remote controller.

6. The display apparatus of claim 2, wherein the temporary picture storage temporarily stores a frame of when a user pushes a store button after selecting the setting key to set the picture quality.

7. The display apparatus of claim 2, wherein the temporary picture storage temporarily stores several neighboring frames such as an anterior frame, a posterior frame, etc. as well as a current frame.

8. The display apparatus of claim 2, wherein the image movement determiner reads the frames of the picture stored in the temporary picture storage and calculates a movement vector of an image, thereby estimating the movement of the image.

9. The display apparatus of claim 8, wherein the image movement determiner uses the current frame and the anterior frame, the current frame and the posterior frame, or the current frame and both the anterior and posterior frames according to operations of the temporary picture storage to estimate the movement of the image.

10. The display apparatus of claim 2, wherein the DCT operation transforms the image from a special domain to a frequency domain.

11. The display apparatus of claim 10, wherein the DCT operator classifies an AC component frequency band into grades from “0” to “100” according to the domains, and determines the frequency band near to “0”, as a low frequency component and the frequency band near to “100” as a high frequency component.

12. The display apparatus of claim 11, wherein the results of the DCT operation are mapped and stored by a one-to-one correspondence with edge enhancement values previously set by a user through the setting key.

13. The display apparatus of claim 1, wherein the picture analyzed value of when a picture quality is set through the setting key is mapped with the setting value set through the setting key in placed in the memory.

14. The display apparatus of claim 1, wherein the setting value includes information about brightness, contrast, sharpness, and tint, and continuously remains as a database until reset.

15. A method of controlling a display apparatus displaying a picture, the method comprising:
analyzing characteristics of the picture;
mapping and storing the analyzed characteristics of the picture with a setting value when picture quality of the picture is set; and
setting the picture quality of the picture on the basis of the setting value corresponding to the stored value nearest to the analyzed characteristics of the picture when an automatic setting is selected.

16. The method according to claim 15, wherein the analyzing of the characteristics of the picture comprises:
storing the picture temporarily;
determining movement of the temporarily stored picture;
applying a discrete cosine transform (DCT) operation to the temporarily stored picture to analyze frequency distribution of the picture with respect to frequency bands;
determining a histogram for the temporarily stored picture; and
determining a picture shift on the basis of the image movement, the frequency distribution, and the histogram.

17. The method according to claim 16, wherein the operation of determining movement of the temporarily stored picture includes calculating a movement vector of an image, thereby estimating the movement of the image.

18. The method according to claim 17, wherein the movement vector indicates a directional moving quantity of an image of a moving object in a picture between an anterior fram and the posterior frame, and is represented as vertical and horizontal components.

19. The method according to claim 16, wherein the DCT operation transforms the image from a spatial domain to a frequency domain.

20. The method according to claim 19, wherein the DCT operation classifies an AC component frequency band into grades from “0” to “100” according to the domains, and determines the frequency band near the value “0” as a low frequency component and the frequency band near “100” as a high frequency component.

21. The method according to claim 15, wherein the setting value includes information about brightness, contrast, sharpness, and tint, and continuously remains as a database until reset.
